(19) United States
(12) Patent Application Publication
(10) Pub. No.: US 2022/0386584 A1
(43) Pub. Date: Dec. 8, 2022

(54) Insect Feeder

(71) Applicant: James Rykbost, Lugoff, SC (US)

(72) Inventor: James Rykbost, Lugoff, SC (US)

(21) Appl. No.: 17/337,797

(22) Filed: Jun. 3, 2021

(51) Int. Cl. A01M 1/10; A01M 23/08

(52) U.S. Cl. CPC A01M 1/103; A01M 23/08; A01M 2200/011

(57) ABSTRACT

A device for trapping and feeding insects to reptiles or the like includes an elongated hollow member carved to resemble a natural hollowed-out log, a screen removably attached to the inside of the elongated hollow member, a removable cap with a screen on the bottom of the elongated hollow member, and dual prongs to attach the device to a screened-in enclosure. The device traps insects and allows them to crawl up the screen, while preventing the insects from escaping the device.

### BACKGROUND OF THE INVENTION

The present invention relates generally to insect feeders for terrariums or other enclosures. More specifically, the present invention includes, in one embodiment a tube carved or formed to look like a natural hollowed-out log, a plastic screen attached to the inside of the tube, metal brads or other attachment means used to connect the plastic screen to the tube, a removable cap on the bottom of the tube, and dual prongs used for attaching the feeder to an enclosure. This configuration is particularly useful for attaching to a screened-in enclosure that houses a reptile or the like.

Heretofore, many efforts have been made to provide mechanisms for trapping insects to feed to reptiles and the like. Some examples are set forth hereinbelow, and each of the following references are incorporated herein by reference, in their entireties:

U.S. Pat. No. 2,745,209 Live Cricket Dispenser

This invention related to live cricket dispensers. It is an object of the present invention to provide a live cricket dispenser which will yield live crickets to a fisherman in a very easy manner, one at a time, for the purpose of bait, live crickets otherwise being of an unmanageable nature. It is another object of the present invention to provide a live cricket dispenser of the above type wherein scores of live crickets may be loaded into the device at one time and wherein one cricket only will be yielded at a time, as needed, and wherein the crickets will remain alive within the dispenser.

U.S. Pat. No. 5,630,374 Cricket Dispenser

Apparatus for storing and dispensing crickets, as food, to a live reptile. A container possesses a smooth inner surface. A hollow tube, whose length exceeds the height of the container, possesses a smooth outer surface and an inner surface suitable for grasping by crickets. A top for the container has an interior aperture for accommodating the tube in a substantially-vertical attitude when inserted. A lateral aperture at the bottom of the container provides ingress for crickets into the tube while a cap at the top assures that the crickets cannot escape.

U.S. Pat. No. 6,338,315 Live Feeder

A feeder container for live insects which is made from transparent material, and the feeder container has mounting elements for mounting the feeder container on an enclosure for a pet. In addition, the feeder container has a self closing opening for capturing insects from the feeder container.

U.S. Pat. No. 6,758,162 Reptile Feeder

A feeding apparatus for use within a terrarium for feeding insects such as crickets to reptiles and/or other animals in the terrarium. The apparatus consists of a structure having a chamber in which the insects can move about, a cover that provides access to the chamber for introducing insects that powder supplements to the chamber, and a small port and manually removable port plug for enabling the insects to exit the chamber to the terrarium when the plug is removed. The structure and cover may create the image of a simulated rock. The feeding apparatus has a substantially flat surface for maintaining the rock structure in a stable position in the terrarium. Also disclosed is a method for feeding reptiles insects comprising the steps of pouring a vitamin powder supplement into a container with insects, closing the container, gently shaking the container to coat the insects with the powder, placing the containing in a terrarium, and uncovering at least one opening in the container for insects to exit the container into the terrarium.

U.S. Pat. No. 7,774,976 Insect Trap

An insect trap has a hollow body generally centered on an upright axis, having a central upwardly open output passage, and formed around the central output passage with an annular intake passage having a dark-colored inner surface. A light-colored foraminous wall upwardly covers the central output passage and has a surface area substantially greater than that of the intake passage. A blower in the body expels air from the body through the central output passage and through the foraminous wall at a predetermined low speed and draws air into the annular intake passage at a high speed substantially higher than the predetermined low speed. Insects attracted by the weak stream or by a contrast between the dark-colored inner surface and the light-colored foraminous wall are trapped in the annular intake passage.

### BRIEF SUMMARY OF THE INVENTION

In accordance with one aspect of the invention, a first embodiment of an insect feeder apparatus for trapping and feeding insects to reptiles and the like includes an elongated hollow member with a section of the outer portion removed to form an opening therein, a screen attached to the inner portion of said elongated hollow member, and a removably attached cap. The cap preferably defines a hole in a central portion thereof, and includes a screen positioned in the center of the cap.

The insect feeder apparatus can be removably attached to a screened-in enclosure for reptiles or the like using attachment means, such as dual prongs with rubber backings, fastening hooks, or the like.

The insect feeder apparatus preferably is made to look like a natural hollowed out log to blend in with the reptile's habitat. Typically, the insect feeder apparatus is made from polyvinyl chloride, other plastic polymers, or other similar materials, although it should be understood that any suitable material may be used.

Insects are placed inside the feeder apparatus. The insect feeder apparatus prevents insects from escaping, while allowing reptiles to see the insects for feeding purposes.

Because this insect feeder, in a preferred embodiment, has the look and feel of a natural log, it can also serve as a reptile bed or hide-away spot.

### BRIEF DESCRIPTION OF THE DRAWINGS

These and other features, aspects, and advantages of the present invention will become better understood with regard to the following description, appended claims, and accompanying drawings where:

FIG. 1 is a perspective view of one embodiment of the insect feeder, wherein the insect feeder is shown in its upright position, with the screen attached to the inside of the insect feeder.

FIG. 2 is a side view of one embodiment of the insect feeder, wherein the screen is attached to the inside of the insect feeder and the dual prongs are attached to the insect feeder and the screen.

FIG. 3 is a bottom view of one embodiment of the insect feeder, wherein the insect feeder includes a removably attached cap, having a screen in the center of the cap.

### DETAILED DESCRIPTION OF THE INVENTION

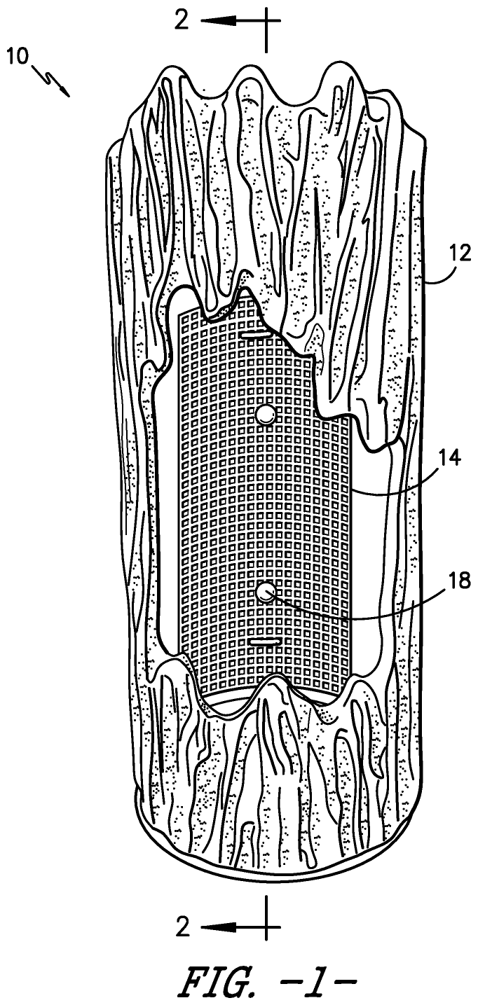

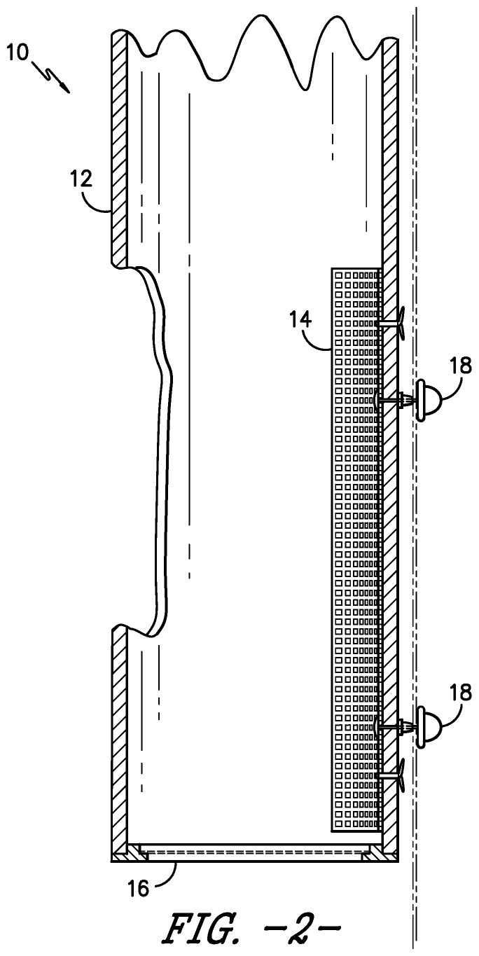

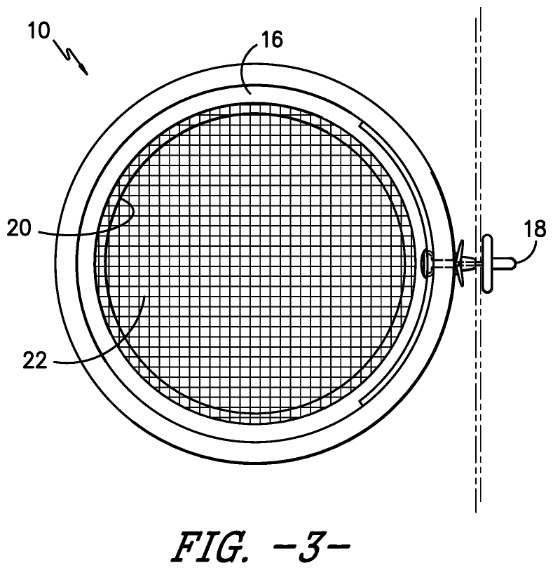

The present invention includes, in a first embodiment, an insect feeder apparatus 10, as shown in FIGS. 1-3, and includes an elongated hollow member 12 with a top portion and a bottom portion, a screen 14 attached to the inner portion of the elongated hollow member 12, and a cap 16 removably attached to the bottom portion 16 of the elongated hollow member 12. The insect feeder apparatus 10 attaches to a screened-in enclosure for reptiles or the like by attachment means 18, such as dual prongs with rubber backings, fastening hooks, or the like.

In a preferred embodiment, the elongated hollow member 12 is a generally cylindrical tube and includes an opening along a side portion thereof. The top portion of the elongated hollow member 12 is open, and a cap 16 removably attaches to the bottom portion of the elongated hollow member 12. The cap 16 may include an aperture 20 located in the center of the cap 16, and screen material 22 covers the aperature 20 on the cap 16. When the cap 16 is attached to the bottom portion of the elongated hollow member 12, insects that are placed within the insect feeder apparatus 10 are contained therein.

The screen 14 is preferably attached to the inner portion of the elongated hollow member 12 by attachment means 18 such as metal brads, push pins, or the like. When in use, this screen 14 allows for the insects placed inside of the insect feeder apparatus 10 to climb the screen 14, while preventing the insects from escaping the insect feeder apparatus 10.

Reptiles or the like may access the interior of the feeder 10 through the opening provided along a side of the elongated hollow member 12 to feed on the insects trapped therein. Preferably, the insect feeder apparatus 10 is carved or otherwise formed to resemble a natural hollowed-out log so that the apparatus 10 blends in with the habitat of the reptile.

Although the present invention has been described in considerable detail with reference to certain preferred versions thereof, other versions are possible. Therefore, the spirit and scope of the appended claims should not be limited to the description of the preferred versions contained herein. All features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

1. An insect feeder apparatus for trapping and feeding insects to live reptiles or the like, comprising:
an elongated hollow member, having a top portion and a bottom portion;
a cap removably attached to said bottom portion of said elongated hollow member; and
a screen removably attached to the inner portion of said elongated hollow member by attachment means.

2. The insect feeder assembly set forth in claim 1, wherein said elongated hollow member defines an opening in a side portion thereof.

3. The insect feeder assembly set forth in claim 1, wherein said elongated hollow member is a generally cylindrical tube.

4. The insect feeder assembly set forth in claim 1, wherein said top portion of said elongated hollow member defines an opening.

5. The insect feeder assembly set forth in claim 1, wherein said cap further includes an aperture located in the center of said cap.

6. The insect feeder assembly set forth in claim 5, further including a screen, wherein said screen covers said aperture of said cap.
